(19) United States
(12) Patent Application Publication
(10) Pub. No.: US 2005/0076176 A1
(43) Pub. Date: Apr. 7, 2005

(54) Circulating recording apparatus, method and program

(76) Inventors: Tomomi Takada, Kodaira (JP); Hirotada Ueda, Kokubunji (JP); Seiichi Hirai, Koshigaya (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/942,887

(22) Filed: Sep. 17, 2004

(30) Foreign Application Priority Data
Sep. 19, 2003 (JP) 2003-327415

(51) Int. Cl. G06F 12/00

(52) U.S. Cl. 711/112; 711/170; 711/113

(57) ABSTRACT

The invention provides a circulating recording apparatus which can dynamically modify the capacity of a circulating recording area while holding a predetermined amount of recording data corresponding to the past. A single circulating recording area of the circulating recording apparatus can include memory areas distributed among a plurality of recording media. The circulating recording apparatus includes a circulating recording area management table composed of a plurality of table entries corresponding to the number of memory blocks constituting the circulating recording area and each entry includes pointer information for accessing the memory blocks and contents information of the data stored in the memory blocks. The data block write operation into the circulating recording area in a circulating manner and the data read operation from a specified memory block are conducted in accordance with the circulating recording area management table.

### CROSS-REFERENCE TO RELATED APPLICATION

The present invention relates to U.S. application Ser. No. 10/852,120 being filed based on May 25, 2004, entitled “Circulating Memory Apparatus and Image Storage Distribution system”. The entire content of which is incorporated herein by reference.

### BACKGROUND OF THE INVENTION

The present invention relates to a circulating recording apparatus for recording data by using a plurality of memory areas in a circulating manner, and more particularly to a circulating recording apparatus suitable for a data recording apparatus for a data storage distribution system which stores a plurality of series of data generated in time series to distribute the data to a data requester.

For example, an image distribution system for a remote monitor system receives, in time series, image data picked up by image pickup devices such as Web cameras from a plurality of sites. The image data thus received are stored in a large-capacity storage apparatus (recording apparatus) such as a magnetic disk, an optical disk, a semiconductor disk, and distributed through a network to the monitor of an image data requester. Accordingly, the operator can monitor the state of each site by use of the monitor screen located at a remote place. The above described image data may include sound information picked up at each site.

In this case, since the capacity of the image data recording apparatus is limited, only a predetermined amount of image data can be recorded and reproduced. Therefore, the above described recording apparatus employs a circulating recording method, in which the memory area secured in a recording media for storing data is accessed in a circulating manner and the oldest image data in time series are sequentially replaced with the latest image data.

When the image data from a plurality of sites are recorded separately for each site, a dedicated circulating recording area for each site (each channel) is defined in the recording apparatus. This allows the recording apparatus to record and reproduce the image data for each channel by means of a circulating recording method. For example, descriptions of the memory address management in a recording apparatus (a circulating recording apparatus) employing the circulating recording method of this type are given in JP-A-11-232842 (pp. 3 to 5, FIGS. 1 to 12).

### SUMMARY OF THE INVENTION

In the conventional recording apparatus employing the above described circulating recording method, each circulating recording area includes memory areas located in a single recording media. And in the conventional recording apparatus, the capacity modification of the circulating recording area during operation is not taken into consideration.

An object of the present invention is to provide a circulating recording apparatus capable of dynamically modifying the capacity of the circulating recording area while holding a predetermined amount of recorded data stored in the past.

Another object of the present invention is to provide a circulating recording apparatus in which a circulating recording area is composed of a plurality of memory areas, each of the memory areas being located in any one of recording media.

In order to achieve the above described object, in the circulating recording apparatus of the present invention, a plurality of memory blocks having a predetermined size used as the circulating recording area are prepared in the recording media and the operating status of each memory block is managed for each recording media. Each circulating recording area includes a required number of vacant memory blocks. The circulating recording apparatus stores data by using these memory blocks in a circulating manner.

More specifically, according to one aspect of the present invention, the circulating recording apparatus of the invention includes a circulating recording area management table. The above described circulating recording area management table includes a plurality of table entries corresponding to the number of the memory blocks composing the circulating recording area. Each entry includes pointer information for accessing a memory block and data contents information with respect to the data stored in the above described memory block. The circulating recording apparatus writes data block into the circulating recording area in a circulating manner and reads the data from a specific memory block, in accordance with the circulating recording area management table.

According to another aspect of the invention, the circulating recording apparatus of the invention includes a memory block status management table for each recording media, which indicates the identifying information and operating status of the memory blocks used as the circulating recording area. By accessing the above described memory block status management table, the circulating recording apparatus generates a new circulating recording area management table in response to a request for generating a new circulating recording area, reorganizes the existing circulating recording area management table in response to a request for modifying the memory capacity of the already generated circulating recording area, and modifies the memory block operating status in accordance with the generation or reorganization of the above described circulating recording area management table.

According to still another aspect of the present invention, the circulating recording apparatus of the invention includes a memory block status management table indicating the identifying information and operating status of each memory block for each recording media. Each of the above described memory block status management table includes a plurality of table entries corresponding to the number of the memory blocks in the circulating recording area. Each entry includes fields for indicating pointer information for accessing a memory block and contents information of the data stored in the above described memory block. When a request for generating a new circulating recording area or a request for expanding the memory capacity of an already generated circulating recording area occurs, the circulating recording apparatus refers to the above described memory block status management table to secure a required number of vacant memory blocks independently of the recording media to which the circulating recording area belongs. The circulating recording apparatus generates a new circulating recording area management table or reorganizes the existing circulating recording area management table by using as a table component a plurality of table entries corresponding to the memory blocks thus secured.

According to the present invention, a single circulating recording area can include memory blocks distributed among a plurality of recording media. Therefore, it is possible to expand or reduce the circulating recording area while holding the latest fraction of recorded data. In addition, according to the present invention, it is possible to facilitate the adjustment of the memory capacity conducted among the circulating recording areas within the range of the storage capacity of the circulating recording apparatus and the expansion of the memory capacity of the existing circulating recording area in the case of additional installment of the recording media.

### BRIEF DESCRIPTION OF THE DRAWINGS

FIG. 1 is a diagram showing a general configuration of an image storage distribution system according to the present invention;

FIG. 2 is a diagram for explaining a circulating recording area for each channel formed in a disk unit;

FIGS. 3A and 3B are diagrams showing an embodiment of a memory block in each recording media used for the circulating recording area and a memory block status management table thereof;

FIG. 4 is a diagram showing an embodiment of an index and a management table for defining the circulating recording area;

FIGS. 5A to 5C are diagrams for explaining a process of reducing the memory capacity of the circulating recording area;

FIGS. 6A to 6C are diagrams for explaining a process of expanding the memory capacity of the circulating recording area;

FIG. 7 is a block diagram showing an embodiment of the image storage distribution server 1 shown in FIG. 1;

FIG. 8 is a flowchart showing an embodiment of a circulating recording area generating routine 400;

FIG. 9 is a flowchart showing an embodiment of a circulating recording area reducing routine 420;

FIG. 10 is a flowchart showing an embodiment of a circulating recording area expanding routine 440;

FIG. 11 is a diagram for explaining operations in which the image storage distribution server 1 writes and reads image data into and from the disk unit;

FIG. 12 is a diagram showing the details of a header attached to a data block and the relationship between the header and the image data recorded in each block of the circulating recording area;

FIG. 13 is a flowchart showing an embodiment of a routine 460 for writing data into the circulating recording area;

FIG. 14 is a functional block diagram of that part of the image storage distribution server 1 which is related to the image data/read operation;

FIG. 15 is a diagram for explaining an embodiment of an operation of editing the data block performed by a receiving thread 21-i shown in FIG. 14; and

FIG. 16 is a diagram for explaining an embodiment of an operation of reading image data and an operation of distributing image frames, each performed by a distribution thread 25-j shown in FIG. 14.

### DESCRIPTION OF THE EMBODIMENT

Embodiments of the present invention will be described below with reference to the accompanying drawings.

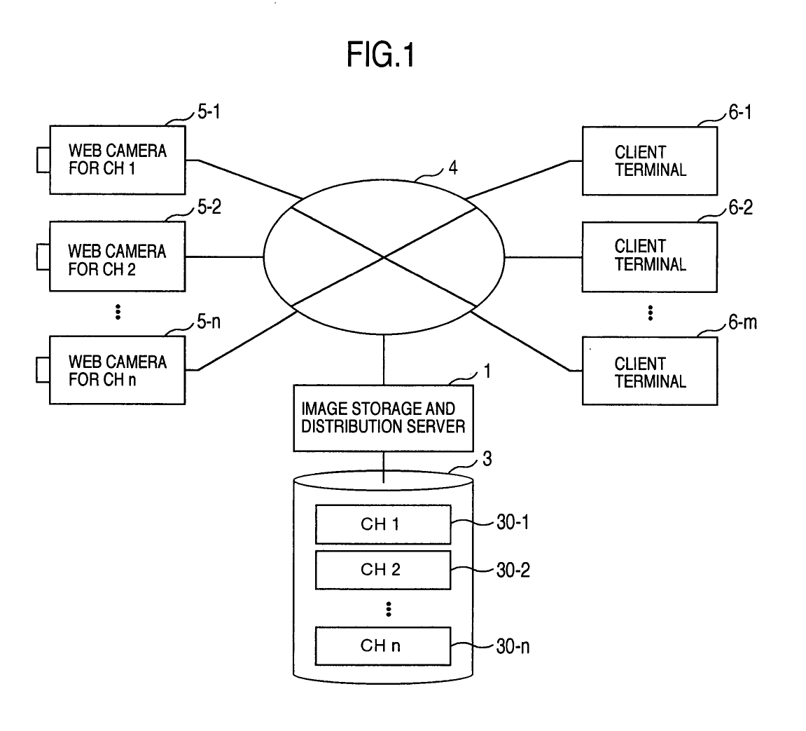

FIG. 1 shows an embodiment of a general configuration of an image storage distribution system to which a circulating recording apparatus and a circulating recording method according to the present invention are applied.

The image storage distribution system shown in the drawing includes: an image storage distribution server 1 equipped with a recording unit 3 (referred to below as a disk unit) for storing image (including sound in some cases) data; a plurality of Web cameras 5 (5-1 to 5-n) connected to the above described image storage distribution server 1 through a network 4; and a plurality of client terminals 6 (6-1 to 6-m). Each of the Web cameras 5-1 to 5-n is associated with its specific channel number; for example, the Web camera 5-1 is used for channel 1 (CH1), the Web camera 5-2 for channel 2 (CH2), . . . , the Web camera 5-n for channel n (CHn), where n and m are natural numbers and n is not necessarily equal to m.

The image data of each frame of images picked up by the Web cameras 5-1 to 5-n is compressed by, for example, the image compression scheme such as JPEG. The compressed image data is sent to the image storage distribution server 1 in the format of IP packet. In this case, the compressed image data is a variable-length data, the amount of data varying according to the image frame. The image storage distribution server 1 extracts the compressed image data (referred to below as an image data for short) from each packet which is received through the network 4 from the Web cameras 5-1 to 5-n and stores the image data into a circulating recording area 30 (30-1 to 30-n) for each channel (for each site), which is secured in the disk unit 3.

As described later, each of the client terminals 6 requests the image storage distribution server 1 to distribute the image data by specifying the channel number and frame number. In response to the request from the client terminal 6, the image storage distribution server 1 distributes to the requesting client terminal 6, in the format of IP packet, the image data having the designated channel number/frame number read from the disk unit 3 or the latest image data being stored in a cache memory. The circulating recording apparatus according to the present invention is applied to the disk unit 3 in the above described image storage distribution system.

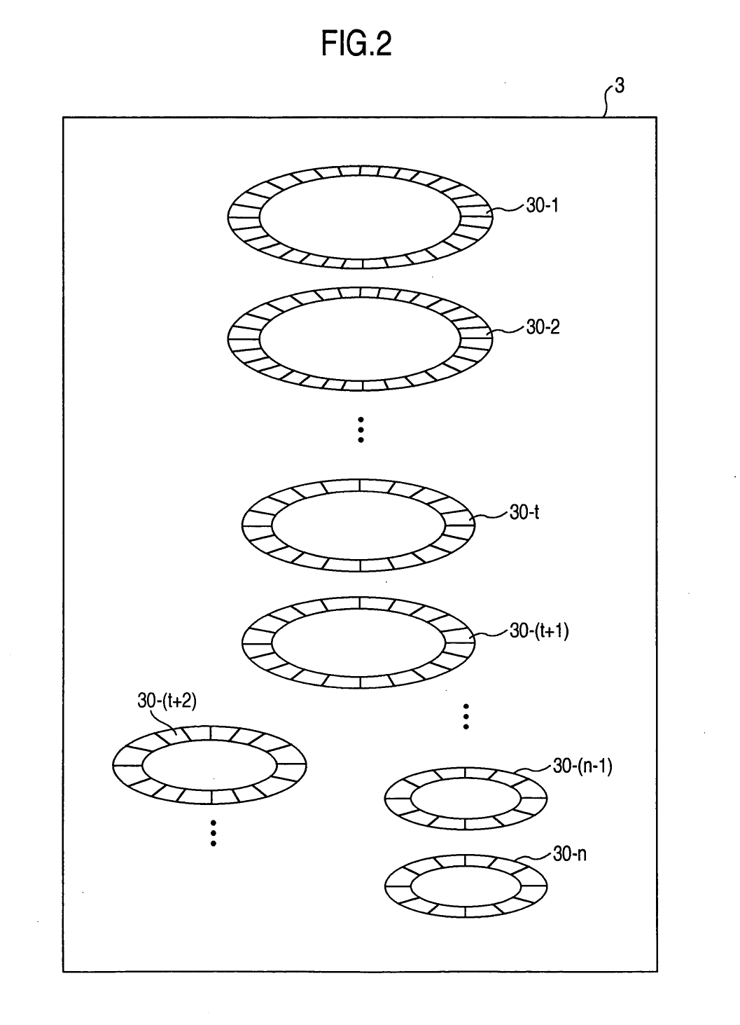

FIG. 2 illustrates the circulating recording area 30 (30-1 to 30-n) for each channel formed in the disk unit 3.

In FIG. 1 and FIG. 2, the disk unit 3 is represented as a single apparatus for convenience. According to the present invention, however, the disk unit 3 may include a plurality of recording media. It is noted that the recording media as the term used herein indicates a single hard disk, a RAID (Redundant Arrays of Inexpensive Disk) composed of a plurality of hard disks, and other random-accessible recording apparatuses, for example.

According to the present invention, by using a plurality of recording media described above, a plurality of circulating recording areas 30 (30-1, 30-t, 30-(t+1), 30-(t+2), . . . , 30-(n−1), 30-n) are formed for each channel in the memory space provided by the disk unit 3 (1≦t≦n).

The size (storage capacity) of the circulating recording area 30 is arbitrary for each channel. In FIG. 2, the difference in size with respect to the circulating recording areas 30 is indicated by the size of a ring schematically representing each of the circulating recording areas 30. Each of the circulating recording areas 30 includes a plurality of memory blocks having a predetermined size. By accessing these memory blocks in a circulating manner, the circulating recording apparatus can record the image data generated in time series in each channel in a format such that a predetermined amount of the recording area succeeding the latest data is saved.

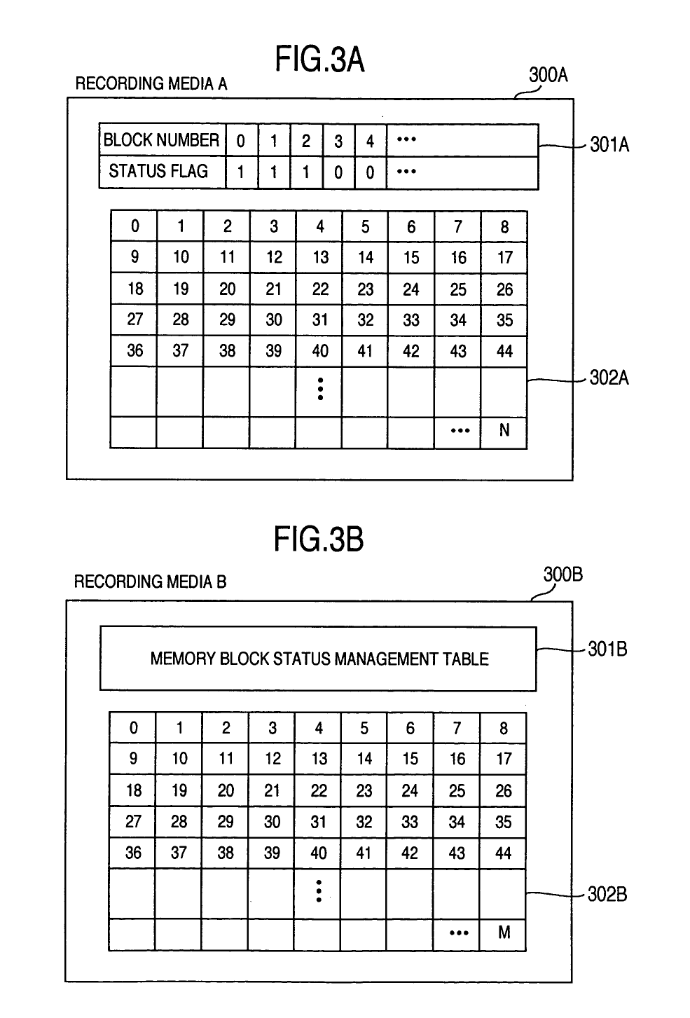

FIGS. 3A and 3B illustrate the memory blocks in each recording media used for the circulating recording area 30 and a memory block status management table which manages the operating status of these memory blocks.

FIG. 3A shows a memory block status management table 301A formed in a recording media 300A having an identifier A and a memory area 302A used for the circulating recording area 30. The memory area 302A is divided into a number N+1 of memory blocks. The above described memory blocks have an identifier 0 to N and a predetermined size (for example, 1 M bytes), respectively. The memory block status management table 301A memorizes a status flag corresponding to the identifier (referred to below as a block number) of each memory block and indicating the operating status of the memory block. The status flag is set to “1” when the memory block is assigned to the circulating recording area; the status flag is set to “0” when the memory block is vacant.

FIG. 3B shows a memory block status management table 301B formed in a recording media 300B having an identifier B and a memory area 302B used for the circulating recording areas 30. The memory area 302B is divided into a number M+1 of memory blocks. The above described memory blocks have an identifier 0 to M and a predetermined size, respectively. Similarly to the memory block status management table 301A, the memory block status management table 301B memorizes the status flag corresponding to the identifier (referred to below as a block number) of each memory block and indicating the operating status of the memory block.

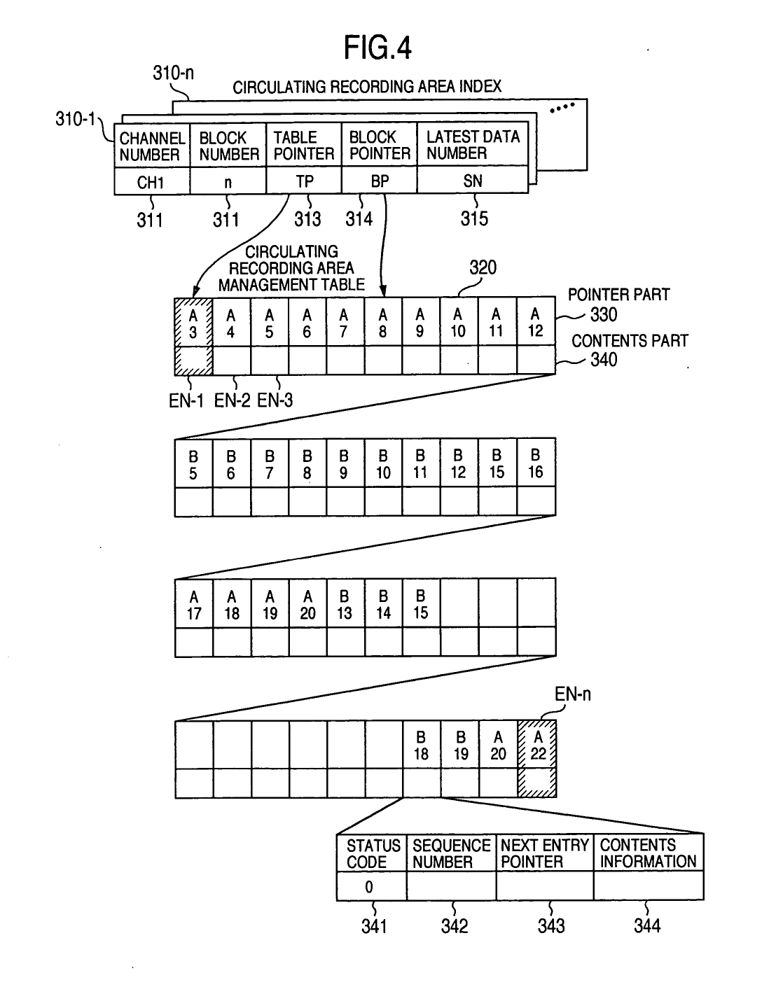

FIG. 4 illustrates the configuration of a circulating recording area index and a circulating recording area management table each generated for defining the circulating recording area. According to the embodiment of the invention, there is formed the circulating recording area index 310 (310-1 to 310-n) corresponding to the circulating recording area 30 (30-1 to 30-n) for each channel; the circulating recording area management table 320 (320-1 to 320-n) linked with each circulating recording area 30 index is formed in the circulating recording area index 310.

The circulating recording area index 310-1 for channel CH1 includes: a channel number 311; a number of blocks 312 indicating the number of memory blocks n (equivalent to the number of entries in the circulating recording area management table 320) which are included in the circulating recording area 30-1; a table pointer (TP) 313 indicating the position of the head entry EN-1 in the circulating recording area management table 320; a block pointer (BP) 314 designating the table entry having the pointer information of the memory block into which the latest data has been written; and a latest data number (SN) 315. The circulating recording area indices 310-2 to 310-n for the other channels are similarly configured.

The circulating recording area management table 320-1 linked with the circulating recording area index 310-1 includes a number n of table entries EN-1 to EN-n. Each entry includes a pointer part 330 and a contents part 340.

The pointer information composed of the identifier of the recording media (for this embodiment, the recording media A and recording media B) and the identifier of the memory block is set in the pointer part 330. The memory blocks in the disk unit 3 are specified by these identifiers. For example, the pointer information “A3” of the head entry EN-1 indicates the 3rd memory block in the recording media 300A shown in FIG. 3A; the pointer information “A22” of the tail entry EN-n indicates the 22nd memory block in the recording media 300A shown in FIG. 3A.

On the other hand, the contents part 340 includes: a status code 341 indicating the status of the memory block designated by the pointer information; a sequence number 342 of the data block recorded in the above described memory block; a next entry pointer 343 indicating the next table entry; and contents information 344.

According to the embodiment of the invention, the next entry pointer 343 of the head entry EN-1 indicates the 2nd entry EN-2; the next entry pointer 343 of the 2nd entry EN-2 indicates the 3rd entry EN-3; the next entry pointer 343 of the tail entry EN-n indicates the head entry EN-1, whereby the table entries EN-1 to EN-n are combined with each other in the shape of a ring. As described later, the contents information 344 in the contents part, extracted from the header attached to each data block, is used for retrieving the data block in which data to be read is located when reading the data from the circulating recording area 30.

The initial value of the block pointer BP included in each index 310 designates the head entry EN-1. By accessing the table entry designated by the block pointer BP, the data is written into the memory block indicated by the pointer information in the pointer part 330. When the next data is written, the value of the block pointer BP is updated, so that the data can be recorded in a circulating manner in the memory block corresponding to the pointer information in the pointer part 330 of the circulating recording area management table 320-1.

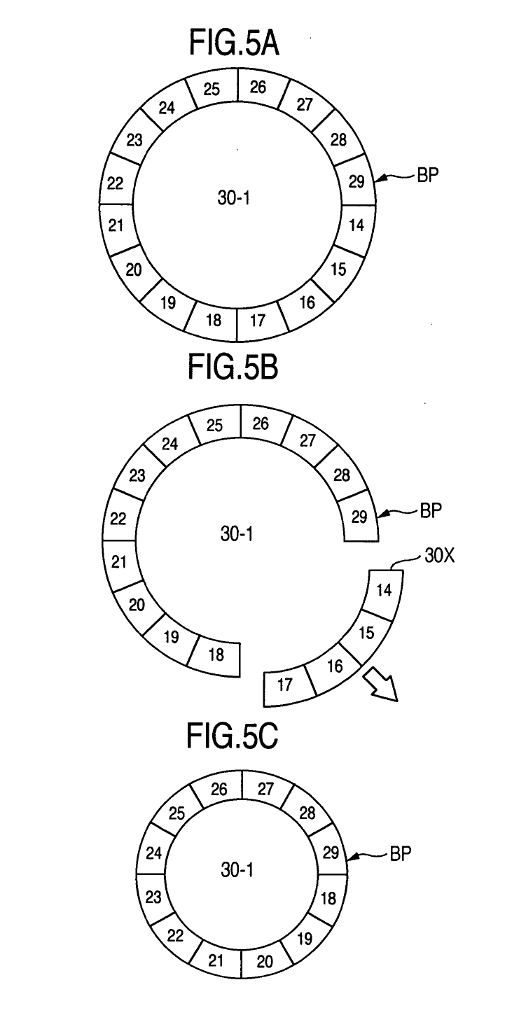

FIGS. 5A to 5C illustrate the process of reducing the memory size (memory capacity) of the circulating recording area 30 which has already been generated and is currently operative.

FIG. 5A schematically illustrates the circulating recording area 30-1 including sixteen memory blocks in which the image data having the sequence number 14 to 29 are stored. Suppose that a request for reducing the memory size by eliminating four memory blocks from the circulating recording area 30-1 occurs. In this case, memory block group 30×arranged in order of older image data, i.e. indicated by the sequence number 14 to 17, is to be eliminated from the circulating recording area 30-1 as shown in FIG. 5B.

In the embodiment shown in FIG. 4, the position of the memory block storing the latest data (in this embodiment, the image data having the sequence number 29) is specified by the block pointer BP in the circulating recording area index 310 corresponding to the circulating recording area 30-1. The next entry pointer 343 of the table entry indicated by the block pointer BP is read from the circulating recording area management table 320. The table entry indicated by this next entry pointer 343 is accessed to specify the memory block in which the oldest image data having the sequence number 14 is stored in accordance with the contents of the pointer part 330 of the above described entry. Similarly, the memory blocks storing the image data having the sequence number 15, 16, and 17 are specified in sequence by repeating the similar operation in accordance with the next entry pointer 343 indicated by the above described table entry.

In the present invention, the memory block to be eliminated can be specified by accessing the circulating recording area management table 320 in this way. According to the pointer information indicating the memory block to be eliminated, the memory block status management table 301 (301A, 301B, . . . ) is accessed, and the status flag corresponding to the pointer information is rewritten to have “0”, whereby the memory block to be eliminated is released. In addition, in the circulating recording area management table 320, the value of the next entry pointer 343 of the table entry indicated by the block pointer BP is rewritten, and by using the pointer information, the above described table entry is linked with the table entry indicating the memory block of the oldest image data (in this embodiment, the image data having the sequence number 18). Accordingly, the table entry group corresponding to the memory blocks to be eliminated is eliminated to reduce the size of the circulating recording area 30-1 as shown in FIG. 5C.

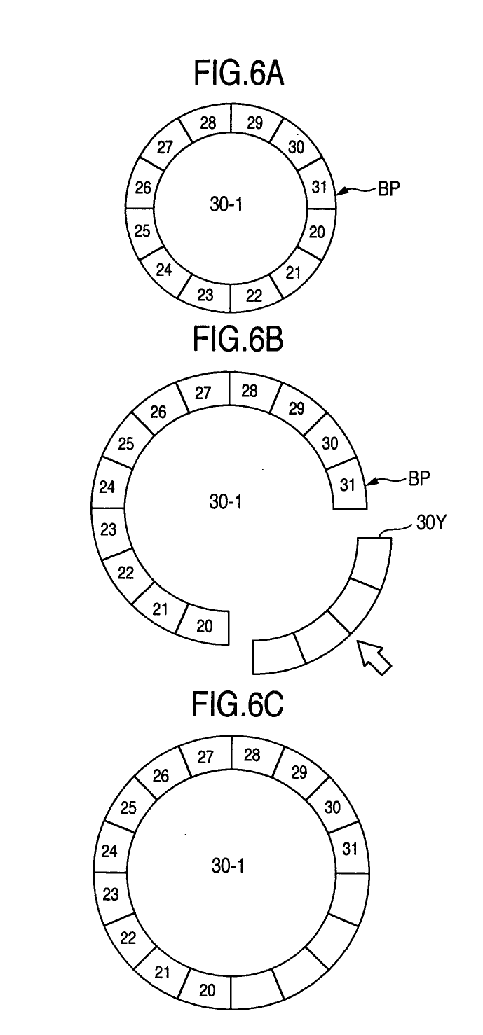

FIGS. 6A to 6C illustrate the process of expanding the memory size of the circulating recording area 30 which is currently operative.

FIG. 6A schematically illustrates the circulating recording area 30-1 including twelve memory blocks in which the image data having the sequence number 20 to 31 are stored. Suppose that a request for adding, for example, four memory blocks occurs in the circulating recording area 30-1. According to the present invention, in response to the above request, additional memory block group 30Y including four vacant memory blocks is secured by accessing the memory block status management table 301 (301A, 301B, . . . ). As shown in FIG. 6B, the additional memory block group 30Y is interposed between the memory block in which the latest image data having the sequence number 31 is stored and the memory block in which the oldest image data having the sequence number 20 is stored. Accordingly, the memory size of the circulating recording area 30-1 can be expanded to a size corresponding to sixteen memory blocks as shown in FIG. 6C. In this case, the additional memory block group 30Y does not necessarily belong to a single recording media, but may be distributed among a plurality of recording media. Furthermore, the additional memory block group 30Y may be disposed in another recording media being different from that of the memory block group composing the existing circulating recording area 30-1, for example, in an additionally installed recording media.

The additional memory block group 30Y is added to the circulating recording area 30-1 through the addition of a group of new table entries and the rewriting of the next entry pointer 343 in the circulating recording area management table 320 shown in FIG. 4. More specifically, the next entry pointer 343 is rewritten so as to link the table entry for the block for storing the latest image data designated by the block pointer BP with the head entry of the additional table entry group and then link the tail entry of the additional table entry group with the table entry for the block for storing the oldest image data designated by the next entry pointer 343 of the table entry for the above described block for storing the latest image data.

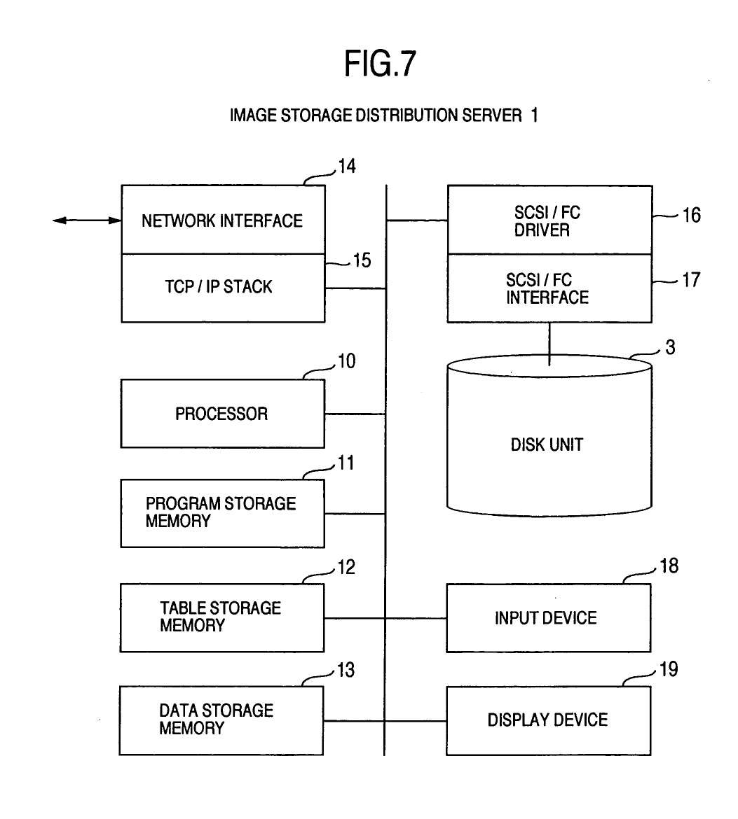

FIG. 7 is a block diagram showing an embodiment of the image storage distribution server 1 equipped with the above described functions of generating the circulating recording area 30 and expanding/reducing the circulating recording area.

The image storage distribution server 1 includes: a processor 10; a program storage memory 11 in which various programs executed by the processor 10 are stored; a table storage memory 12 in which the circulating record of image data for each channel and various tables being necessary for the distribution service to clients are formed; and a data storage memory 13 used as a buffer area for transmitting and receiving image frames and as a cache area for writing and reading image data. The image storage distribution server 1 further includes: a network interface 14 for the connection with a network 4; a TCP/IP stack 15; a fiber channel driver 16 and a fiber channel interface 17 each used as the connection interfaces of a disk unit 3; an input device 18; and a display device 19. It is noted that if the object of the present invention is achieved, the above described image storage distribution server 1 is not limited thereto and may be different from the above described configuration.

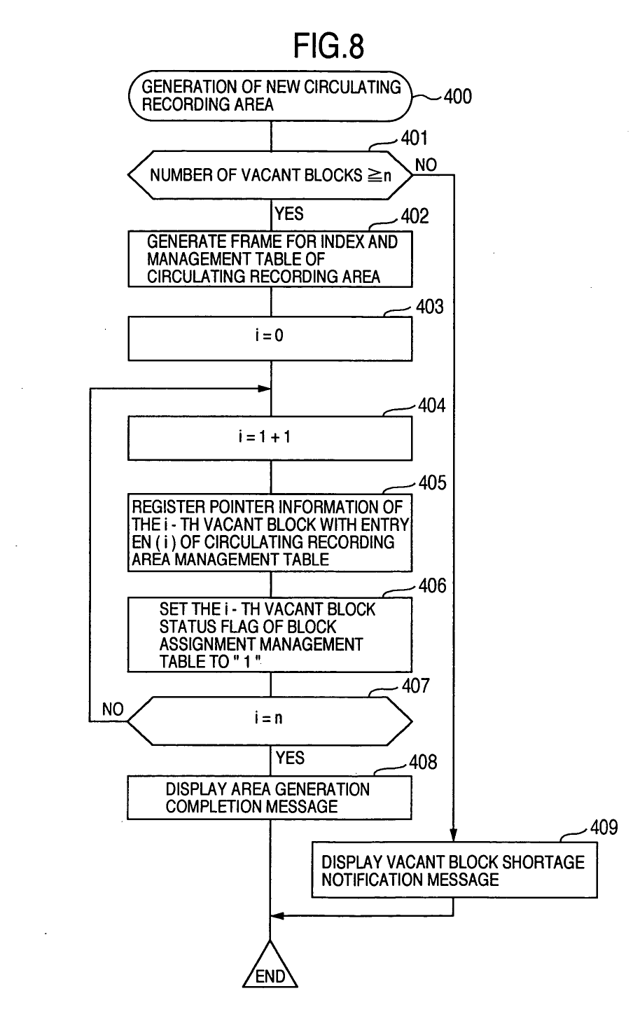

FIG. 8 is a flowchart showing an embodiment of a routine 400 for generating a circulating recording area 30 provided in the program storage memory 11. The circulating recording area generating routine 400 is executed, for example, when the operator gives an instruction on generating a new circulating recording area 30 by designating the channel number CHk and the number of memory blocks n on the circulating recording area defining screen displayed in the display device 19.

In the new circulating recording area generating routine 400, by accessing the status flag of the memory block status management table 301 (301A, 301B, . . . ) prepared for each recording media, it is decided whether vacant blocks corresponding to the number-of memory blocks n designated by the operator exist in the circulating recording area (Step 401). If there is a shortage of vacant blocks, a vacant block shortage notification message is displayed in the display device 19 (Step 409), and this routine is completed. In this case, the number of securable vacant blocks or the number of lacking vacant blocks may be displayed in the display device 19 so that the operator can again give an instruction on generating the circulating recording area 30 by reducing the scale of the area.

When vacant blocks corresponding to the number of memory blocks n exist in the circulating recording area 30, the frame for the circulating recording area index 310-k and circulating recording area management table 320-k each for the channel CHk are generated in the table storage memory 12 (Step 402). At this time, the channel number CHk and number of memory blocks n designated by the operator are set in the channel number 311 and number of blocks 312 of the circulating recording area index 310-k, respectively. The address of the head entry of the circulating recording area management table 320-k is set in the table pointer 313 and block pointer 314, respectively. The latest data number 315 is set to the initial value “0”. The circulating recording area management table 320-k includes a number n of entries linked with each other in the shape of a ring. The status of the fields of the pointer part 330 and contents part 340 for each entry is cleared, except for the next entry pointer 343.

Next, the value of the parameter i for specifying the entry of the circulating recording area management table 320-k is set to the initial value “0” (Step 403). The value of the parameter i is incremented (Step 404), and then the pointer information indicating the i-th vacant block of the memory block status management table 301 (any one of 301A, 301B, . . . ) is registered in the pointer part 330 of the i-th entry EN (i) of the circulating recording area management table 320-k (Step 405). The i-th status flag in the memory block status management table 301 is set to “1”, indicating that the memory block is currently operative (Step 406), and then it is decided whether the parameter i has reached the designated value n (Step 407).

If the parameter i has not reached the designated value n, the process returns to the Step 404. The value of the parameter i is incremented, and thereafter the similar operation is repeated. Accordingly, the pointer information indicating the vacant memory block is sequentially registered in the circulating recording area management table 320-k. When the registration of the pointer information with respect to the last n-th entry and the setting of the status flag for the particular memory block are completed, the circulating recording area 30 generation completion message is displayed in the display device 19 (Step 408). Then, this routine is completed.

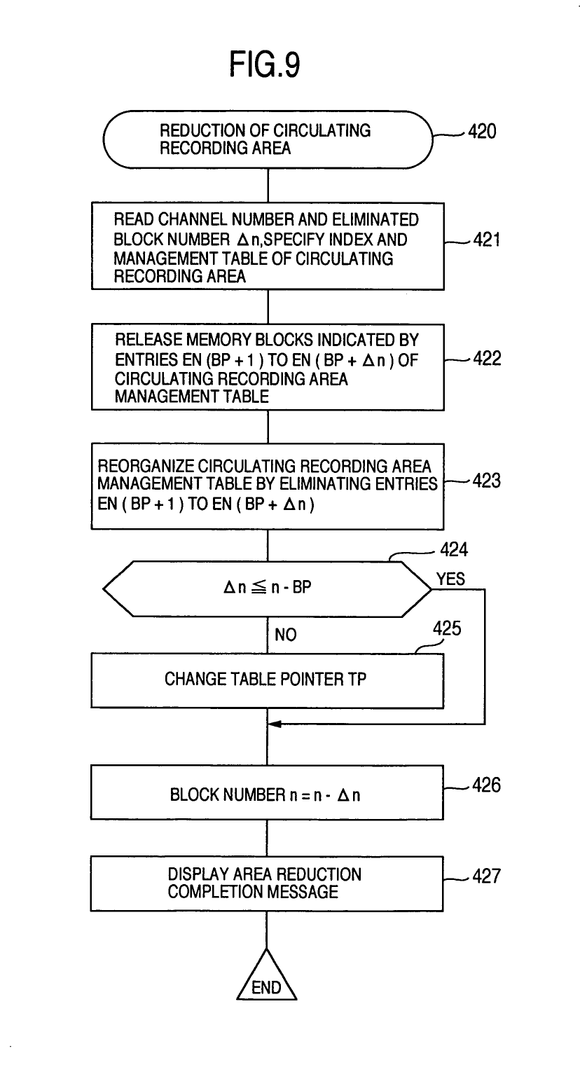

FIG. 9 is a flowchart showing an embodiment of a circulating recording area 30 reducing routine 420 prepared in the program storage memory 11. The circulating recording area 30 reducing routine 420 is executed, for example, when the operator gives an instruction on reducing the circulating recording area 30 by designating the channel number CHq and the number of eliminated memory blocks Δn on the circulating recording area defining screen displayed in the display device 19.

The circulating recording area 30 reducing routine 420 is executed according to the following procedure. First, the channel number CHq and the number of eliminated memory blocks Δn are read so as to specify the circulating recording area index 310-q and circulating recording area management table 320-q each for the channel number CHq to be modified (Step 421). As described in FIG. 5, a number Δn of entries succeeding to the table entry indicated by the block pointer BP is to be eliminated from the circulating recording area management table 320-q by reducing the circulating recording area 30. For convenience, assume that the entries to be eliminated are EN (BP+1) to EN (BP+Δn).

Next, in accordance with the pointer information of the entries to be eliminated EN (BP+1) to EN (BP+Δn), the status flag of the particular memory blocks in the memory block status management table 301 (any one of 301A, 301B, . . . ) is shifted to “0” to sequentially release the memory blocks corresponding to the entries EN (BP+1) to EN (BP+Δn) (Step 422). Then, the circulating recording area management table 320-q is reorganized to eliminate the entries EN (BP+1) to EN (BP+Δn) (Step 423). In the table configuration shown in FIG. 4, the reorganization of the above described circulating recording area management table 320-q is achieved by replacing the value of the next entry pointer 342 of the table entry indicated by the block pointer BP with the value of the next entry pointer of the last entry EN (BP+Δn) to be eliminated.

Next, the value of Δn is compared with the value of n−BP (Step 424). In the circulating recording area management table 320-q before modification, if the entry EN-n is the tail entry, the value of n−BP indicates the number of entries that follow the table entry designated by the block pointer BP. If the value of Δn is larger than the value of n−BP, it indicates that the head entry EN-1 of the circulating recording area management table 320-q is included in the entries EN (BP+1) to EN (BP+Δn) to be eliminated. In this case, the value of the table pointer (TP) 313 of the circulating recording area index 310-q is modified in accordance with the head entry of the circulating recording area management table 320-q after modification (Step 425). Then, the value of the number of blocks 312 in the circulating recording area index 310-q changes from n to n−Δn (Step 426), and the circulating recording area 30 reduction completion message is displayed in the display device 19 (Step 427). And then, this routine is completed.

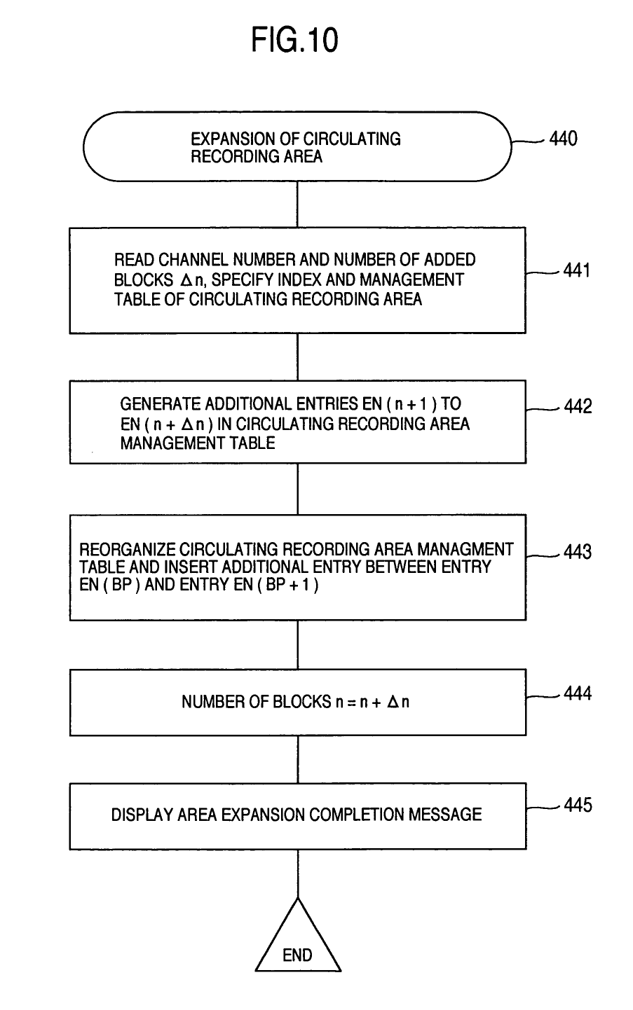

FIG. 10 is a flowchart showing an embodiment of a circulating recording area 30 expanding routine 440 prepared in the program storage memory 11. The circulating recording area 30 expanding routine 440 is executed, for example, when the operator gives an instruction on expanding the circulating recording area 30 by designating the channel number CHr and the number of added memory blocks Δn on the circulating recording area defining screen displayed in the display device 19.

The circulating recording area 30 expanding routine 440 is executed according to the following procedure. First, the channel number CHr and the number of added memory blocks Δn are read so as to specify the circulating recording area index 310-r and circulating recording area management table 320-r each for the channel number CHr to be modified (Step 441). Next, the table entry group EN (n+1) to EN (n+Δn) is added to the circulating recording area management table 320-r (Step 442). The table entry group EN (n+1) to EN (n+Δn) corresponds to a number Δn of blocks to be added. Except for the tail entry EN (n+Δn), these added entries are linked with the succeeding entries by the next pointer, respectively. Similarly to when the circulating recording area 30 is generated, the identifying information and recording media identifier of the vacant memory blocks acquired by accessing the status flag of the memory block status management table 301 (301A, 301B, . . . ) provided for each recording media are registered as each pointer information in the added entries.

Next, the above described entry group EN (n+1) to EN (n+Δn) is interposed between the table entry EN (BP) indicated by the block pointer BP and the subsequent table entry EN (BP+1) to reorganize the circulating recording area management table 320-r (Step 443). The above described table reorganization is achieved by rewriting the next entry pointer 343 so that the next entry pointer 343 of the table entry EN (BP) is linked with the first entry EN (n+1) of the added entry group and the next entry pointer 343 of the tail entry EN (n+Δn) is linked with the table entry EN (BP+1) designated by the next entry pointer 343 of the above described table entry EN (BP).

When the reorganization of the circulating recording area management table 320 is completed, the value of the number of blocks 312 in the circulating recording area index 310-r changes from n to n+Δn (Step 444). Then, the circulating recording area 30 expansion completion message is displayed in the display device 19 (Step 445). And this routine is completed. It is noted that when the vacant memory blocks corresponding to the requested number Δn cannot be secured in Step 442, a vacant block shortage notification message is displayed in the display device 19 as with the circulating recording area 30 generating routine 400, and then this routine is completed.

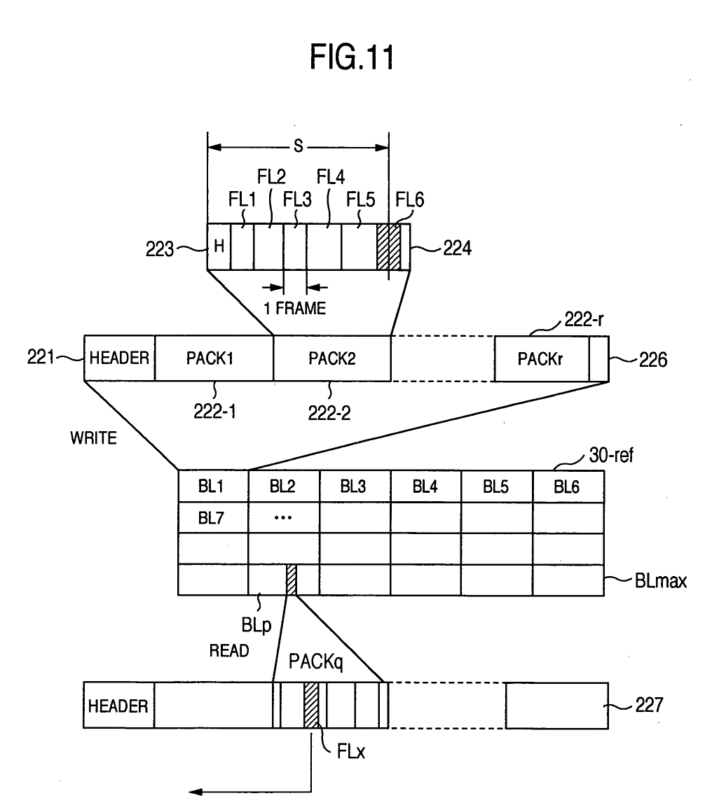

FIG. 11 shows an embodiment of the image data write/read operation in the disk unit 3 performed by the image storage distribution server 1 according to the present invention.

As with a hard disk, in a recording apparatus in which the reading/writing of data involves the operation of seeking the target track, while the speed of reading/writing data is high with respect to a sequential access to the recording area, the above speed is low with respect to a random access. In addition, in order to efficiently access the disk, the data transfer size is preferably a multiple of the sector size of the disk unit 3. Therefore, in the image storage distribution server 1 according to the present embodiment, the image data received by frame from the Web camera 5 are stored sequentially for each channel into cache memory (referred to below as a disk write cache area). The image data thus stored are edited into data blocks having a size of an integer multiple of the sector size and written by block into the disk unit 3.

More specifically, according to the present embodiment, circulating recording area 30-ref defined for each channel in the disk unit 3 is partitioned into a plurality of memory blocks having a fixed size BL1, BL2, . . . BLmax as shown in FIG. 11, for example. The image data are sequentially written by block into the memory blocks, starting with the starting memory block BL1. The image data recording in which the memory area is used in a circulating manner, i.e. the circulating recording is implemented by, after writing the image data into the last memory block BLmax, writing the succeeding image data into the starting memory block BL1. It is noted that the circulating recording area 30-ref denotes any one of a plurality of circulating recording areas 30-1 to 30-n shown in FIG. 1.

In disk write cache area 226, the image data written into the circulating recording area 30-ref are edited into the data block including a header 221 and a plurality of variable-length sub-blocks 222 (222-1 to 222-r). The data blocks thus edited are written by block into each memory block BL1, BL2, . . . BLmax. It is noted that r is a natural number. The image data including a plurality of frames FL1, FL2, FL3, . . . are recorded in each of these sub-blocks. Hereinafter, such sub-block is referred to as a “pack” or a “PACK”. Each pack 222 has a length of an integer multiple of the sector size. In the starting position of each pack, there is arranged a pack header (H) 223 which indicates position information designating in units of a byte the starting position of the frames in the above pack and preferably indicates the time information of the frames.

According to the present embodiment, subsequently to the pack header (H) 223, the image frames FL1, FL2, . . . are sequentially stored in each pack 222. When the basic size S is exceeded by storing the image data into the last image frame (for example, frame FL6), a vacant area 224 is adjusted so that the size of the pack is equal to an integer multiple of the sector size. Accordingly, the size of the pack is variable and substantially equal to the basic size S.

As an alternative method, in the case where the pack size exceeds the basic size S through the storage of the last image frame (for example, FL6), the recording of the above described last image frame into the particular pack may not be performed to set the area for the image frame FL5 and subsequent image frames as a vacant area and record the last image frame FL6 into the next pack. In this case, the size of the pack 222 is equal to the basic size S.

It is noted that the block BL is composed of a plurality of packs and each block has a predetermined length.

For reading the image data from the circulating recording area 30-ref, on the other hand, a read mode (hereinafter referred to as the first mode) based on the pack including the frame designated by the client terminal 6 or a read mode (hereinafter referred to as the second mode) based on the data block including the designated frame is selectively used according to the circumstances. This is by reason of the fact that in the case where the image is reproduced normally or reversely at the normal or less than normal speed at the client terminal 6, for example, the second mode in which the image data is read by block is used from the viewpoint of efficiency, while in the case where random frames selected discontinuously at the client terminal 6 are reproduced, many of the data read in the second mode become wasteful, resulting in a low access efficiency.

In the first mode, for example, assume that the client terminal 6 issues a request for an image frame FLx included in the block BLp. The image storage distribution server 1 reads out the pack (PACKq) including the designated frame FLx from the circulating recording area 30-ref, writes the pack into the disk read cache area 227, and selecting the designated frame FLx from the pack (PACKq), distributes it to the client device of the requester. When the designated frame already exists in the disk read cache area 227, the image data is not required to be read from the circulating recording area 30-ref; when the designated frame has been stored in the disk write cache area 226, the image storage distribution server 1 distributes the image frame read from the disk write cache area 226 to the client device of the requester.

In the case where the frame request from the client terminal 6 presupposes a reproduction mode suitable for reading by block, the second mode instead of the first mode is selected, and the image data corresponding to one block including the designated frame is read out into the disk read cache area 227. In this case, the designated frame is selected from the previously read image data blocks and sequentially distributed to the client terminal 6 in response to subsequent transmitting requests.

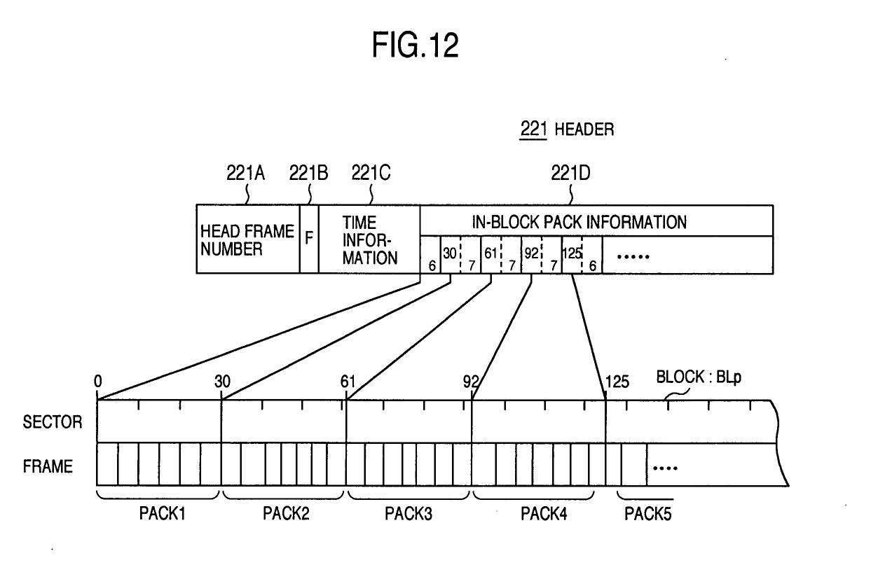

FIG. 12 shows the details of the header 221 attached to each data block and the relationship between the image data recorded in the block BL (for example, block BLp, where p is a natural number satisfying the equation p≦max) of the circulating recording area 30 and the data block.

The header 221 is composed at least of the frame number of the starting frame (starting frame number) 221A included in the starting pack of the data block, a status flag 221B, time information 221C and in-block pack information 221D. The time information 221C is set as the time information of the starting frame in the data block.

The in-block pack information 221D includes a plurality of fields corresponding to a plurality of packs composing the data block. The first field includes a single value (composed of 8 bits, for example), which indicates the number of frames included in the starting pack of the data block. For example, the second and subsequent fields are each composed of two values (composed of 8 bits, respectively, for 31′ example). The first value indicates the address of the starting sector of the pack, and the second value the number of frames in the pack. The number of fields made available in the in-block pack information 221D is limited, and therefore the number of packs included in each data block also has an upper limit.

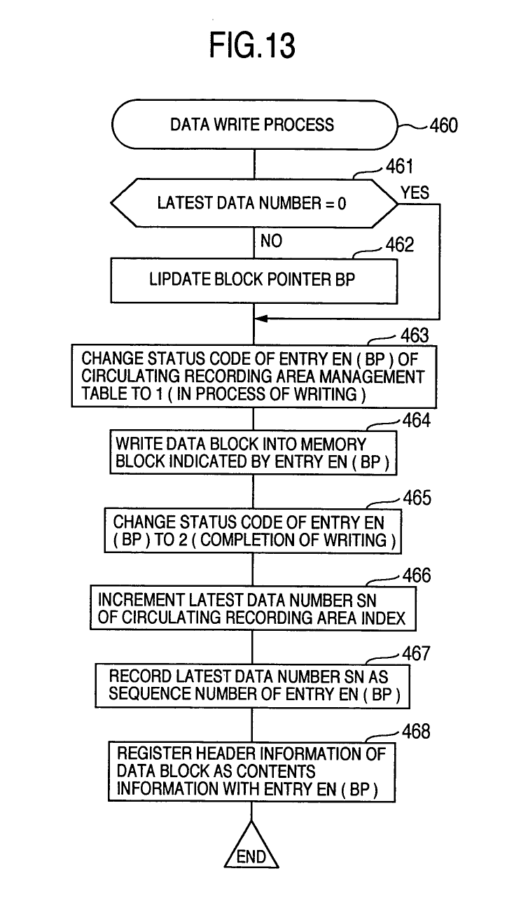

FIG. 13 is a flowchart showing the basic operation of a data write processing program (routine) 460 for writing the image data block of any given channel CH-ref edited in the disk write cache area 226 into the circulating recording area 30-ref.

In the data write processing routine 460, a circulating recording area index 310-ref corresponding to the channel CH-ref is accessed to decide whether or not the value SN of the latest data number 315 is equal to 0 (Step 461). If the latest data number SN is equal to the initial value 0, the value BP of the block pointer 314 is not changed; if the latest data number SN is not equal to the initial value 0, then the block pointer value BP is replaced with a value indicated by the next entry pointer 343 of the table entry EN (BP) designated by the above described block pointer (Step 462).

Next, in the circulating recording area management table 320-ref accompanying the above described index 310-ref, the status code 341 of the table entry EN (BP) designated by the block pointer BP is changed to a value indicating “data writing”, for example, “1” (Step 463). Then, the image data block edited in the disk write cache area 226 is written into the memory block indicated by the pointer information 330 of the table entry EN (BP) (Step 464). When the image data block write process is completed, the status code 341 of the table entry EN (BP) is changed to a value indicating the completion of writing data, for example, “2” (Step 465). Subsequently, the value SN of the latest data number 315 of the index 310-ref is incremented (Step 466). The value SN is recorded as the sequence number 342 of the table entry EN (BP) (Step 467). Furthermore, the starting frame number, time information and other information included in the header 211 of the above described data block (image data) are registered as the contents information 344 into the table entry EN (BP) (Step 468), and this routine is completed. It is noted that the two statuses “1” and “2” are provided for the status code 341 so as to prohibit the reading of image data from the memory block when the status code is “1” (i.e. during data write operation).

As illustrated in the circulating recording area management table 320 shown in FIG. 4, a plurality of table entries are linked with each other in the shape of a ring through the next entry pointer 343. By changing the value of the block pointer BP every time the image data block is written, it becomes possible to access the next table entry having the pointer information which indicates the position (the identifier of recording media and the memory block identifier) of the memory block into which the data is written. According to the present embodiment, therefore, a predetermined amount of image data following the latest frame can be stored in a format such that the image data are stored in order of the sequence number into the vacant memory block immediately after the generation of the circulating recording area 30, and in a format such that the memory block in which the oldest image data is stored is overwritten by the latest image data after the image data have been written into all the memory blocks.

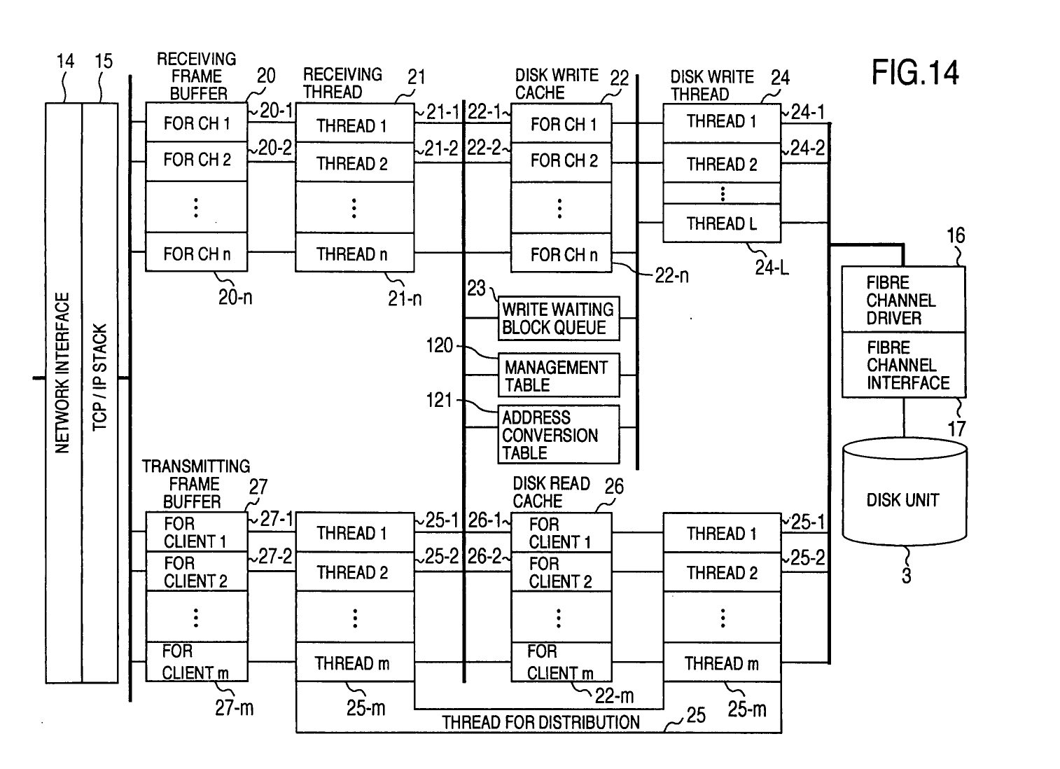

FIG. 14 is a functional block diagram showing an embodiment of that part of the image storage distribution server 1 according to the present invention which is related to the image data write/read operation described above.

According to the present embodiment, a plurality of receiving frame buffers 20 (20-1 to 20-n) and disk write caches 22 (22-1 to 22-n) corresponding to the channel number are formed in the data storage memory 13 (FIG. 7). A plurality of transmitting frame buffers 27 (27-1 to 27-m) and disk read caches 26 (26-1 to 26-m) corresponding to the number of the client terminals m are also formed in the data storage memory 13 described above.

A reference numeral 120 denotes a management table memory area, which holds the above described circulating recording area index 310 corresponding to the above channel and management table 320 and the memory block status management table 301 read out from each recording media. A reference numeral 121 denotes an address conversion table, which is used for converting into the disk address the address of the memory block specified by the logical pointer information of the circulating recording area management table 320 or specified by the channel number and block number.

The image frame packets transmitted from the Web cameras 5 are received by a network interface 14, and the image frames are extracted therefrom by a TCP/IP stack 15 and input to the receiving frame buffers 20 (20-1 to 20-n) corresponding to the channel number. The image frames input to the receiving frame buffer 20 are transferred to the disk write caches 22-i (22-1 to 22-n) by the receiving threads 21 (21-1 to 21-n) corresponding to the channel number. The image frames thus transferred are edited as a data block including a plurality of packs shown in FIG. 11, in the disk write cache area 226 provided in each of the disk write caches 22-i (22-1 to 22-n).

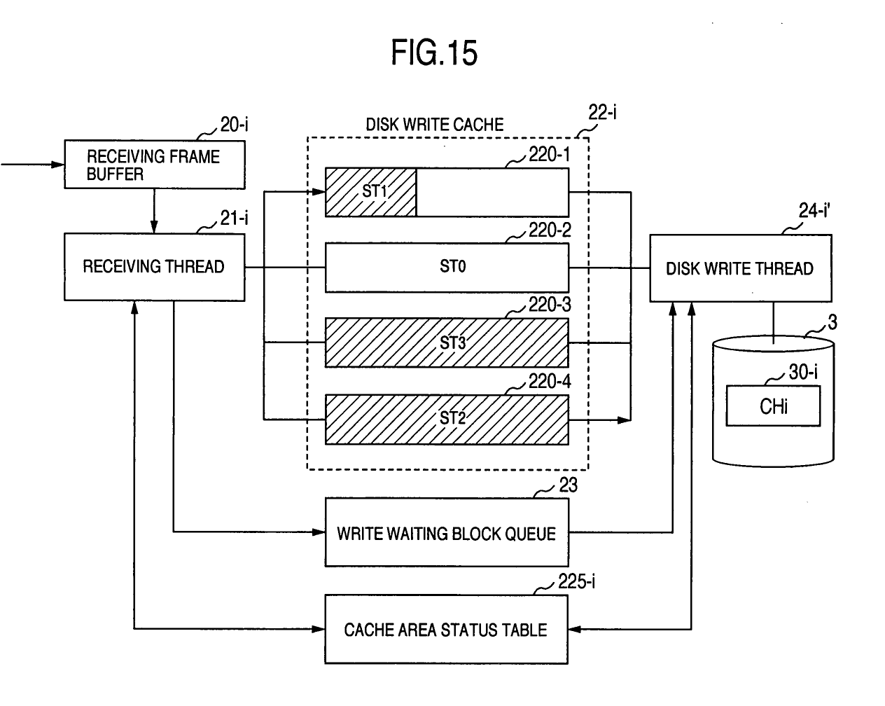

The receiving thread 21 is a program in real terms for processing the received image frames prepared in the program storage memory 11. According to the present embodiment, as described in detail with reference to FIG. 15, each disk write cache 22-i corresponding to each channel is composed of a plurality of cache areas (220-1, 220-2, . . . ). Upon completion of editing a data block in a given cache area, each receiving thread 21 edits the frames received after the above described editing operation as the next data block in another cache area.

After completing the editing of a given data block in a cache area, each receiving thread 21 generates a control block indicating a channel number, a block number and an identifier of the cache area where the above edited data block is located. The control block thus generated is registered in the write waiting block queue 23.

It is noted that the write waiting block queue 23 may be of FIFO (first-in first-out) type.

The disk write thread 24 (24-1 to 24-L, where L is a natural number equal to or smaller than n) is a program in real terms prepared in the program storage memory 11 for processing the data block and having the data write processing function described in FIG. 13. The disk write thread 24 retrieves the control block from each write waiting block queue 23, and in accordance with the channel number, the cache area identifier and the block number indicated by the above described control block, reads out one of the data blocks from the disk write cache 22. Next, in accordance with the channel number CHj indicated by the above described control block, the disk write thread 24 accesses the circulating recording area index 310-j and circulating recording area management tables 320-j corresponding to the above described channel number CHj and stored in the management table memory area 120 to thereby specify the pointer information of the memory block into which the above described data block is to be written. Then, the above described pointer information is converted into the disk address through the address conversion table 121. In accordance with the disk address, the above described data block is written at the specified memory block position of the circulating recording area 30-j in the disk unit 3.

The distribution thread 25 (25-1 to 25-m) is also a program in real terms prepared in the program storage memory 11 for processing the transmitting data. In response to an image frame distribution request from each client terminal 6 (6-1 to 6-m), the distribution thread 25 reads the image data by pack or by block from the disk unit 3 into the disk read cache 26 according to the first or second mode, and transfers the designated image frame to the transmitting frame buffer 27 (27-1 to 27-m). The image frame input to the transmitting frame buffer 27 is converted into the IP packet by the TCP/IP stack 15 and transmitted to the network 4 through the network interface 14.

Each client terminal 6 (6-1 to 6-m) requests the distribution of the image frame from the image storage distribution server 1 by designating the channel number and the frame number. The distribution thread 25 accesses the circulating recording area management table 320 of the designated channel in the memory area 120 and specifies the block number and pack position where the image frames requested by the client are included while at the same time specifying the disk address corresponding to the above described channel number and the block number by use of the address conversion table 121. The image data read operation in the first mode is performed based on the above described disk address and pack position, while the image data read operation in the second mode is carried out based on the above described disk address.

FIG. 15 shows the operation of editing the data block performed by the receiving thread 21-i for the i-th channel (channel i). According to the present embodiment, four cache areas 220-1 to 220-4 are made available as the disk write cache 22-i for the i-th channel. The status of the cache area includes “vacant” (ST0), “editing” (ST1), “write waiting” (ST2) and “write complete” (ST3). The current status of each cache area is recorded in the cache area status table 225-i.

The receiving thread 21-i accesses the cache area status table 225-i and selects a vacant (ST0) cache area from the disk write cache 22-i. After changing the above cache area status code to the editing status ST1, the receiving thread 21-i edits the data block of the image frame. When there is no vacant (ST0) cache area, the cache area including the data block with the oldest time information 221C is selected from the cache areas in the write complete status by the receiving thread 21-i (ST3). This status code is changed to the editing status ST1 by the receiving thread 21-i, and then the data block is edited in the above described cache area.

The receiving thread 21-i, upon completion of editing one data block in the cache area, changes the status code of the above described cache area from ST1 to ST2 on the cache area status table 225-i, and generates the control block related to the above described cache area. The control block thus generated is registered in the write waiting block queue 23.

The disk write thread 24-i′ retrieves the control block from the write waiting block queue 23. It is noted that, in the case where the write waiting block queue 23 is of FIFO type, the above described data block may be the starting control block of the write waiting block queue. In accordance with the above described control block, the disk write thread 24-i′ reads the data block of the cache area in the write waiting state (ST2) from the disk write cache 22-i and then writes the above described control block into the circulating recording area 30-i for the i-th channel of the disk unit 3. Then, the disk write thread 24-i′ changes the status code of the cache area where the write operation into the disk unit is completed from ST2 to ST3 on the cache area status table 225-i, thereby finishing the write process for one data block.

The time required for writing the data block by the disk write thread 24-i′ is shorter than the time required for generating the data block by the receiving thread 21-i. Therefore, the data blocks of all the channels of the disk write cache 22 may be written into the disk unit 3 by a number L of disk write threads 24 (24-1 to 24-L), if L is smaller than the number of channels n. According to the present embodiment, the four cache areas 220-1 to 220-4 are provided for the disk write cache 22-i. However, at least one cache area may be required for each channel, and the maximum number of the cache areas may be arbitrary. Also, the number of the cache areas for each channel may be set to 2 so as to use the cache area as a double buffer. For example, one of the double buffer is used to fill the pack (frame data), and the other to wait for writing in the disk.

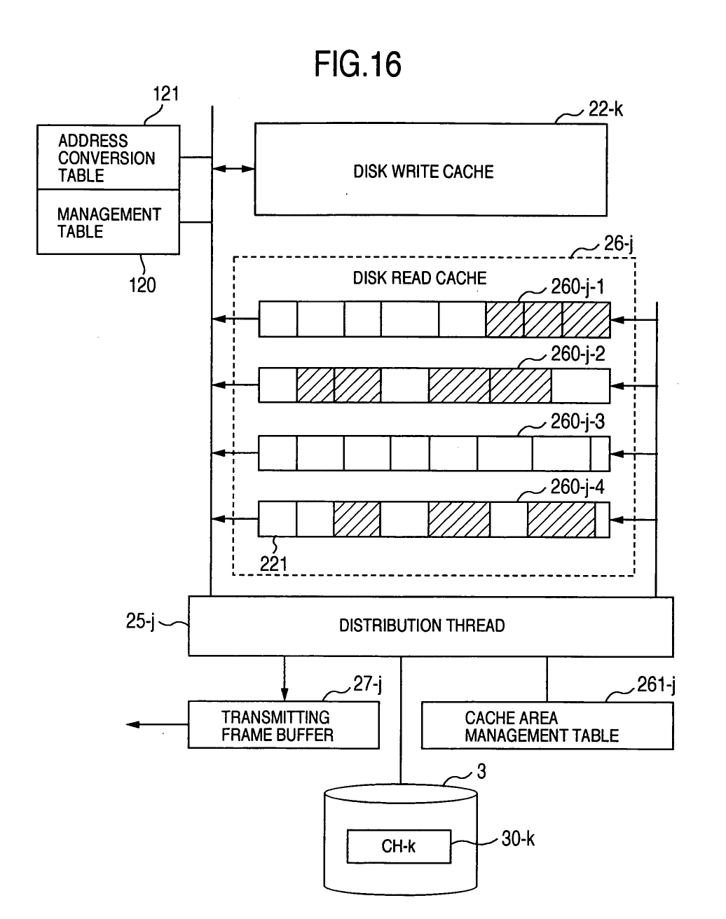

FIG. 16 shows the operation of reading the image data in the first mode and distributing the image frame performed by the distribution thread 25-j in response to an image frame distribution request from the client terminal 6-j, where j is a natural number equal to or smaller than m (j≦m).

According to the present embodiment, four cache areas 260-j-1 to 260-j-4 are made available as the disk read cache 26-j for the client terminal 6-j. In order to determine the correspondence between each cache area and the image data block read into the above described cache area, the index information of the read data block obtained from the circulating recording area management table 320 and the latest access time with respect to each cache memory area, each corresponding to the identifier of the cache area, are registered in the cache area management table 261-j by the distribution thread 25-j.

The disk read cache 26-j, as shown in FIG. 16, has a plurality of cache areas 260-j-1 to 260-j-4 for each client terminal to read the image data corresponding to a plurality of blocks. In the first mode, however, as indicated by hatching in FIG. 16, the image data is read by pack into each cache area. Even in the case where a cache area is already assigned to the data block associated with the requested frame, therefore, the pack including the requested frame is not necessarily existent in the cache area. More specifically, each of the four cache areas has information indicating a particular disk address of the data thereof. For example, assume that the cache 260-j-1 is assigned the data of the disk address 1000. In the first mode, the whole block size (cache size) is not read at one time, but only the required pack is read into the cache area 260-j-1. The required pack is read into the address of the cache area corresponding to the address with respect to the block. For the pack of 99 bytes from the 100th byte in the block, for example, the read operation starts with the 100th byte on the cache memory. In the first mode, therefore, the desired pack data may not be existent on the cache area even when the cache 26-j-1 is assigned the disk address 1000.

The distribution thread 25-j, upon receipt of the image frame distribution request message from the client terminal 6-j, extracts the channel number k and the requested frame number x from the received message, where k is a natural number satisfying the relation 1<k≦n. Next, in accordance with the channel number k and the requested frame number x, the distribution thread 25-j accesses the circulating recording area management table 320-k for the above described channel number k in the management table memory area 120 to retrieve the contents information 344 registered in the above described table, thereby deciding whether or not the requested frame number is currently existent in the circulating recording area 30-k or the disk write cache 22-k.

In the case where the requested frame number x is older than the oldest accessible frame number indicated in the circulating recording area management table 320-k, the requested frame number is replaced with the oldest frame number by the distribution thread 25-j. In the case where the requested frame number x is newer than the newest accessible frame number, on the contrary, the distribution thread 25-j operates so that the requested frame number is replaced with the newest frame number, followed by checking whether the requested frame is existent in the disk write cache 22-k or the disk read cache 26-j. Specifically, in the disk write cache 22-k and the disk read cache 26-j, the circulating recording process may cause the already overwritten data to be accessed. Then, in the case where the number of the frame requested by the client is associated with the portion erased by overwriting (in other words, the portion older than the oldest frame number on the disk), the distribution thread 25-j operates so that the requested frame number is replaced with the oldest frame number on the disk to execute the process described above. In the case where the number of frame requested by the client is newer than the newest frame number held, on the other hand, the requested frame number is replaced with the newest frame number thus held to execute the process described above. For executing the process with the frame number replaced with the newest one, the write cache 22-k is searched for the desired data. In the case where no such data is existent, the disk read cache 26-j is searched for the desired data.

The presence or absence of the requested frame in the disk write cache 22-k is decided by checking the header 221 of each data block stored in the cache area. The presence or absence of the requested frame in the disk read cache 26-j is decided by checking whether the data block including the requested frame is already assigned to any one of the cache areas 260-j-1 to 260-j-4, based on the index information registered in the cache area management table. In the case where the data block is already assigned, the position of the pack containing the requested frame in the data block is specified by use of the in-block pack information 221D constituting part of the above described index information to thereby decide whether the pack data is already read at the specified position of the particular cache area.

In the case where the requested frame is existent in any of the caches described above, the distribution thread 25-j reads the image frame FLx of the requested frame number x from the cache and copies it to the frame buffer 27-j. In the case where the image frame FLx is read from the disk read cache 26-j, the distribution thread 25-j updates the value of the last access time of the cache area holding the above described data block registered in the cache area management table 261-j to the latest access time (current time).

In the case where the data block corresponding to the requested frame is already assigned to any one of the cache areas 260-j-1 to 260-j-4 and the pack containing the requested frame is yet to be read into the cache area, the distribution thread 25-j reads the pack containing the requested frame from the circulating recording area 30-k of the disk unit 3 corresponding to the channel number k and, after storing the pack thus read into the corresponding position of the already assigned cache area, copies the requested frame to the frame buffer 27-j. Also in this case, the value of the last access time of the cache area holding the above described data block registered in the cache area management table 261-j is updated to the latest access time.

In the case where the data block corresponding to the requested frame is existent in neither the write cache 22-k nor the read cache 26-j, the distribution thread 25-j finds an unused cache area from the read caches 26-j and, after clearing the above described cache area, assigns it to the data block read area of the requested frame to thereby read the pack containing the requested frame from the disk unit 3. In the absence of an unused cache area in the disk read cache 26-j, on the other hand, the distribution thread 25-j finds the cache area having the oldest last access time from the cache area management table 261-j. The above described cache area, after being cleared, is assigned to the data block read area of the requested frame to thereby read the pack containing the requested frame from the disk unit 3.

What is referred to as the assignment of the data block read area herein indicates the operation in which the index information of the new data block determined from the circulating recording area management table 320 is registered in accordance with the identifier of the assigned cache area in the cache area management table 261-j, and the value of the last access time of the above described cache area is set as the latest access time.

According to the embodiment described above, the configuration is described in which each entry of the circulating recording area management table 320 is linked to the succeeding entry by the next entry pointer 343. Alternatively, according to another embodiment, the management table 320 may be configured such that, without using the next entry pointer, a plurality of table entries are accessed in order of arrangement to sequentially read the-pointer information, and when the pointer information is read from the last table entry of the circulating recording area management table 320, the reading operation returns to the first table entry of the circulating recording area management table 320.

In the case where the table configuration described above is employed, when a group of entries are formed for the expansion of the memory capacity in the circulating recording area 30, the management table may be reorganized, for example, such that after the new entry group is added so as to succeed the existing last table entry, the entry data of the particular table entry EN (BP) and subsequent table entries are moved toward the last entry so that the above described added entry group is arranged next to the table entry EN (BP) indicated by the block pointer BP. Similarly, when a group of entries are eliminated for the reduction of the memory capacity in the circulating recording area 30, the entry data of the particular table entry EN (BP) and subsequent table entries are moved toward the eliminated entries and then the unused entries formed at the tail end of the management table are deleted.

According to the embodiment shown in the FIG. 14, the disk write thread 24 covers the function of the data write processing routine 460 for updating the circulating recording area management table 320. In another embodiment, the receiving thread 21 may cover one part of the above function. According to this embodiment, the receiving thread 21 sequentially edits the data blocks by use of a plurality of cache areas and, by registering the control block corresponding to the data block thus edited with the write waiting block queue 23, informs the disk write thread 24 about the generation of the data block. Therefore, a time difference arises between the generation of the data block in the receiving thread 21 and the writing of the data block into the circulating recording area 30 in the disk write thread 24. Accordingly, in the case where the receiving thread covers one part of the function of the above described data write processing routine, the updating timing between the block pointer BP and the status code 341 is required to be taken into consideration.

For example, the block pointer BP is divided into a pointer BP1 for the receiving thread 21 and a pointer BP2 for the disk write thread 24. The receiving thread 21 updates the pointer BP1 whenever the data block is generated. The disk write thread 24 updates the status code 341 and the pointer BP2 whenever the data block is written. According to this method, whenever the data block is generated, the receiving thread 21 can access the pointer information of the circulating recording area management table 320 to thereby specify the memory block into which the above described data block is to be written and add the disk address determined from the address conversion table 121 to the control block. Therefore, without accessing the address conversion table 121, the disk write thread 24 can specify the disk address directly from the control block to achieve the operation of writing the data block.

According to the present invention, the memory block in which the latest data has been stored can be specified by the block pointer BP. The block pointer BP, however, may be omitted. For example, a method may be employed such that the sequence number of the contents part of the circulating recording area management table is accessed at the time of writing the data block so as to find a vacant memory block or the memory block in which the oldest data has been stored and write the succeeding data block into the particular memory block. Accordingly, the above described updating timing of the block pointer BP is not required to be considered and thus the receiving thread and the disk write thread can access the circulating recording area management table independently of each other. As the status code of the table entry, a status code may be provided which indicates that the receiving thread has generated the data block and the control block. A transition from this status code to the status code of data write completion takes place during the data write operation.

As apparent from the embodiment described above, in the circulating recording apparatus of the present invention, a single circulating recording area can include memory blocks distributed among a plurality of recording media. In addition, it is possible to expand or reduce the circulating recording area while holding the latest part of recorded data. Therefore, the circulating recording apparatus of the present invention is useful as a recording apparatus for the time series information such as image, sound and sensor information, which utilizes random access recording media. Furthermore, according to the present invention, it is possible to facilitate the adjustment of the memory capacity conducted among a plurality of circulating recording areas within the range of the storage capacity of the recording apparatus and to facilitate the expansion of the memory capacity of the existing circulating recording area in the case of additional installment of the recording media.

It should be further understood by those skilled in the art that although the foregoing description has been made on embodiments of the invention, the invention is not limited thereto and various changes and modifications may be made without departing from the spirit of the invention and the scope of the appended claims.

1. A circulating recording apparatus comprising:
a circulating recording area including a plurality of memory blocks for storing data, wherein each of the memory blocks is arranged on one or more recording media; and
a circulating recording area management table including a plurality of entries, wherein each entry corresponds to each of the memory blocks, respectively, and includes pointer information for specifying the memory block to be accessed and contents information indicating an operating status of the memory block and identifying information of the memory block to be accessed next time,
wherein the data is written in a circulating manner into the memory block of the circulating recording area in accordance with the circulating recording area management table; and
wherein the data is read out from the memory block of the circulating recording area by accessing the circulating recording area management table.

2. The circulating recording apparatus according to claim 1 further comprising a memory block status management table indicating the identifying information of the memory block and the operating status of the memory block for each recording media,
wherein in response to a request for generating a new circulating recording area, the memory block status management table is accessed to generate a new circulating recording area management table;
wherein in response to a request for modifying a memory capacity of an already generated circulating recording area, the memory block status management table is accessed to reorganize an existent circulating recording area management table; and
wherein the operating status of the memory block is changed in accordance with the generation or reorganization of the circulating recording area management table.

3. The circulating recording apparatus according to claim 2, wherein the request for modifying the memory capacity of the already generated circulating recording area indicates a request for expanding or reducing the memory capacity.

4. The circulating recording apparatus according to claim 2, wherein the circulating recording area management table is dynamically reorganized while holding a predetermined amount of recorded data which was recorded in the past.

5. The circulating recording apparatus according to claim 2, wherein reading the data from the memory block is prohibited when the status code of the memory block indicates that a data write operation into the data block is under way; and
wherein reading data from the memory block is permitted when the status code of the memory block indicates that the data write operation into the data block is completed.

6. The circulating recording apparatus according to claim 2 further comprising a circulating recording area index,
wherein the circulating recording area index includes a table pointer indicating a position of a head entry of the circulating recording area management table and a block pointer having information of the memory block into which a latest data has been written.

7. The circulating recording apparatus according to claim 6, wherein when a request for modifying the memory capacity takes place, the data corresponding to a requested predetermined amount of memory blocks starting with a next data block with respect to the block pointer is changed.

8. A circulating recording apparatus for storing data by using in a circulating manner a plurality of memory blocks arranged on one or more recording media, comprising:
a memory block status management table indicating identifying information and an operating status of each memory block for each recording media; and
a plurality of circulating recording area management tables, wherein each of the circulating recording area management tables includes a plurality of entries, each entry corresponding to each memory block of a circulating recording area and including pointer information for specifying the memory block to be accessed and contents information indicating a status of the memory block in which the data has been stored,
wherein when a request for generating a new circulating recording area or a request for expanding a memory capacity of an already generated circulating recording area occurs, the memory block status management table is accessed to acquire a required number of vacant memory blocks independently of the recording media to which the circulating recording area belongs, and a plurality of table entries corresponding to the memory blocks are used as a table component to generate the new circulating recording area management table or reorganize the existent circulating recording area management table.

9. A method of recording in a circulating manner in a circulating recording area comprising a plurality of memory blocks into which data is stored, for a circulating recording apparatus including a circulating recording area and a circulating recording area management table, wherein the circulating recording area management table includes pointer information for specifying the memory block to be accessed and contents information having an operating status of the memory block and identifying information of the memory block to be accessed next time,
the method comprising the steps of:
writing the data in a circulating manner into the memory blocks of the circulating recording area in accordance with the circulating recording area management table; and
reading out the data from the memory blocks of the circulating recording area in accordance with the circulating recording area management table.

10. The method of recording according to claim 9, wherein the circulating recording apparatus further comprises a memory block status management table indicating the identifying information of the memory block and the operating status of the memory block for each recording media,
the method comprises:
a step in which, in response to a request for generating a new circulating recording area, the memory block status management table is accessed to generate a new circulating recording area management table;
a step in which, in response to a request for modifying a memory capacity of an already generated circulating recording area, the memory block status management table is accessed to reorganize an existent circulating recording area management table; and
a step in which an operating status of the memory block is changed in accordance with the generation or reorganization of the circulating recording area management table.

11. A method of recording in a circulating manner in a circulating recording area comprising a plurality of memory blocks into which data is stored, for a circulating recording apparatus including a circulating recording area and a circulating recording area management table, wherein the circulating recording area management table includes a plurality of entries, each entry corresponding to each memory block of the circulating recording area and including pointer information for specifying the memory block to be accessed and contents information indicating an operating status of the memory block in which the data has been stored,
the method comprises a step in which when a request for generating a new circulating recording area or a request for expanding a memory capacity of an already generated circulating recording area occurs, identifying information and an operating status of each memory block indicated in a memory block status management table are accessed to acquire a required number of vacant memory blocks independently of the recording media to which the circulating recording area belongs, and a plurality of table entries corresponding to the memory blocks are used as a table component to generate a new circulating recording area management table or reorganize an existent circulating recording area management table.

12. A program for recording in a circulating manner in a circulating recording area comprising a plurality of memory blocks in which data is stored, the program comprising a circulating recording area management table,
wherein the circulating recording area management table includes: pointer information for specifying a memory block to be accessed; and contents information including an operating status of the memory block and identifying information of the memory block to be accessed next time,
the program comprises:
a program code for writing the data in a circulating manner into the memory block of the circulating recording area in accordance with the circulating recording area management table; and
a program code for reading out the data from the memory block of the circulating recording area by accessing the circulating recording area management table.

13. The program according to claim 12 further comprising a memory block status management table indicating identifying information of the memory block and an operating status of the memory block for each recording media, the program comprises:
a program code for accessing the memory block status management table to generate a new circulating recording area management table, in response to a request for generating a new circulating recording area;
a program code for accessing the memory block status management table to reorganize an existent circulating recording area management table, in response to a request for modifying a memory capacity of an already generated circulating recording area; and
a program code for changing an operating status of the memory block in accordance with the generation or reorganization of the circulating recording area management table.

14. A program for recording in a circulating manner in the circulating recording area comprising a plurality of memory blocks in which data is stored, the program comprising the circulating recording area management table,
wherein the circulating recording area management table includes a plurality of entries, each entry corresponding to each memory block of the circulating recording area and including pointer information for specifying the memory block to be accessed and contents information indicating an operating status of the memory block in which the data has been stored,
the program comprises a program code in which when a request for generating a new circulating recording area or a request for expanding a memory capacity of an already generated circulating recording area occurs, identifying information and an operating status of each memory block indicated in the memory block status management table are accessed to acquire a required number of vacant memory blocks independently of the recording media to which the circulating recording area belongs, and a plurality of table entries corresponding to the memory blocks are used as a table component to generate a new circulating recording area management table or reorganize an existent circulating recording area management table.
